(19) United States
(12) Patent Application Publication
(10) Pub. No.: US 2013/0062418 A1
(43) Pub. Date: Mar. 14, 2013

(54) RFID TAG HAVING COUPLED RESONATOR LOOP WITH LOADING

(71) Applicant: Craig WEAKLEY, Simpsonville, SC (US)

(72) Inventor: Craig WEAKLEY, Simpsonville, SC (US)

(21) Appl. No.: 13/441,237

(22) Filed: Apr. 6, 2012

Related U.S. Application Data
(60) Provisional application No. 61/472,315, filed on Apr. 6, 2011.

(51) Int. Cl. G06K 19/077

(52) U.S. Cl. 235/492

(57) ABSTRACT

Most on-metal asset tracking RFID tags consist of a core material (e.g. ceramic, FR4, rigid foam, etc.) with an EPC Gen2 standards based integrated circuit (IC) attached to an antenna. This invention adds a high dielectric material (some plastics, all ceramics, etc.) placed on the surface of the antenna and a metallic foil (Copper, Aluminum, etc.) placed above (at a distance from) the antenna. These materials effectively “load” the antenna, reducing the rate of change in the antenna impedance. Reducing the rate of change increases the operational bandwidth of the antenna. This approach has been demonstrated both in theory, and practice. Using the approach described above, tags can perform to worldwide application requirements, i.e., they function well within the entire 866 MHz-954 MHz range.

### CROSS-REFERENCE TO RELATED APPLICATIONS

This application is based on and claims priority to U.S. Provisional Application No. 61/472,315, filed Apr. 6, 2011, the entire contents of which is fully incorporated herein by reference.

### BACKGROUND OF THE INVENTION

1. Field of the Invention

The EPC (Electronic Product Code) Class 1 Gen 2 (“Gen2”) RFID standard in combination with regional governing bodies, have defined a global UHF RFID band from 860-960 MHz for operation of RFID systems. For reasons pre-dating the Gen2 standard, a narrowing subset of this band is used in specific geographies. The three most commonly used frequency bands are:

866-869 MHz (EU)

902-928 MHz (North America)

952-954 MHz (Japan)

Regions outside North America, Europe, and Japan have adopted one of these frequency bands.

Historically passive on-metal RFID tags were tuned to operate optimally in one of the frequency bands referenced above. This is known as ‘narrowband’ tuning. Prior art tag designs do not operate well across the entire UHF RFID frequency spectrum and address application requirements, and thus it has been customary to use “country-specific” tags that operate optimally within the band used in a particular country but which will not operate optimally (or at all) in the other bands. To encourage the adoption of RFID technologies, it is extremely important for on-metal, asset tracking tags to operate in all three bands so that they can function in all regions. This is even more important as the United States and other countries expand business globally and establish a true “world economy.”

### SUMMARY OF THE INVENTION

This disclosure describes a novel approach for increasing the operational (frequency) bandwidth of such RFID tags.

Most on-metal asset tracking RFID tags consist of a core material (e.g. ceramic, FR4, rigid foam, etc.) with an EPC Gen2 standards based integrated circuit (IC) attached to an antenna. This disclosure adds the use of a high dielectric material (some plastics, all ceramics, etc.) placed on the surface of the antenna and a metallic foil (Copper, Aluminum, etc.) placed above (at a distance from) the antenna. This material effectively “loads” the antenna, reducing the rate of change in the antenna impedance. Reducing the rate of change increases the operational bandwidth of the antenna. This approach has been demonstrated both in theory, and practice. Using the approach described above, tags can perform to worldwide application requirements. The figures below depict embodiments of the tag design.

### BRIEF DESCRIPTION OF THE DRAWINGS

FIG. 1 is a top view looking down on an RFID chip according to an embodiment of the claimed invention, in which the cover of the RFID chip is removed to facilitate viewing of the RFID chip enclosure;

FIG. 2 is a partial cross-sectional side view of an RFID chip according to an embodiment of the claimed invention, in which the cover is in place;

FIG. 3 depicts the antenna impedance of the antenna without any modifications.

FIG. 4 displays the antenna impedance with the ceramic loading.

FIG. 5 displays the antenna impedance with both ceramic loading and the metallic foil.

FIG. 6 illustrates dimensions and characteristics of a preferred embodiment.

### DETAILED DESCRIPTION OF THE PREFERRED EMBODIMENTS

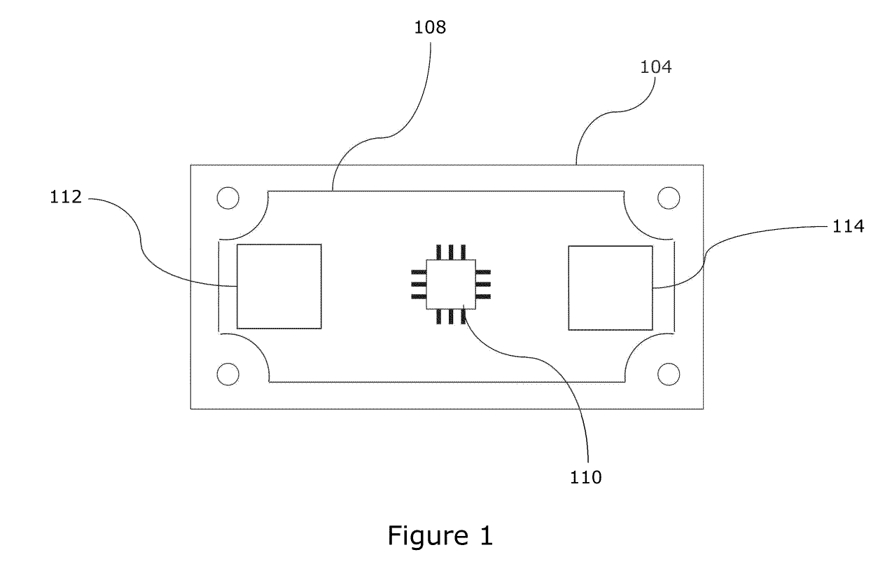

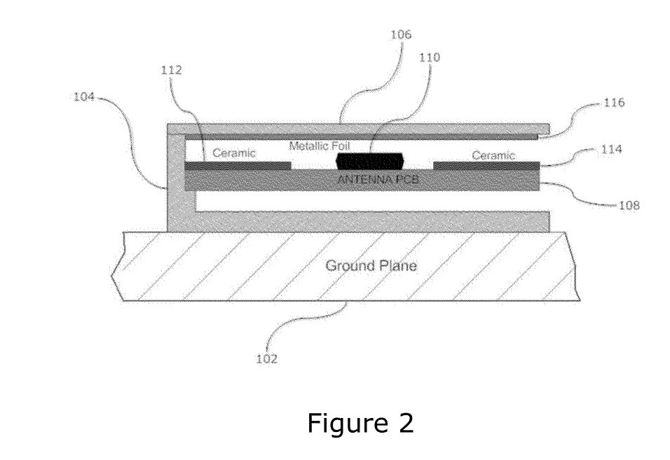

FIG. 1 is a top view looking down on an RFID chip according to an embodiment of the claimed invention, in which the cover of the RFID chip is removed to facilitate viewing of the RFID chip enclosure. FIG. 2 is a partial cross-sectional side view of an RFID chip according to an embodiment of the claimed invention, in which the cover is in place. Referring to FIGS. 1 and 2, a bottom enclosure 104 is mounted on a ground plane 102. Ground plane 102 typically comprises a metallic surface. Bottom enclosure 104 can comprise an RF friendly plastic or ceramic material, and in a preferred embodiment designed to assure survivability under conditions where temperatures range from −55 degrees Fahrenheit to 180 degrees Fahrenheit, the bottom enclosure 104 comprises acrylonitrile butadiene styrene (ABS) plastic.

A passive RFID chip 110 is mounted on an antenna 108. A passive RFID chip can compromise a bare die, chip and strap, or packaged part and typically comprises a QFN packaged part. An antenna 108 can comprise a printed circuit board (PCB), rigid foam, ceramic, or plastic material and typically comprises FR4 PCB material. The mounting procedure typically comprises solder or a conductive adhesive and in a preferred embodiment a high temperature solder.

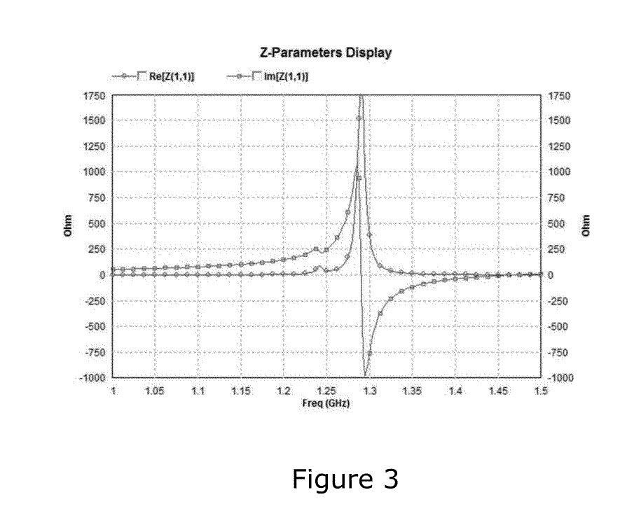

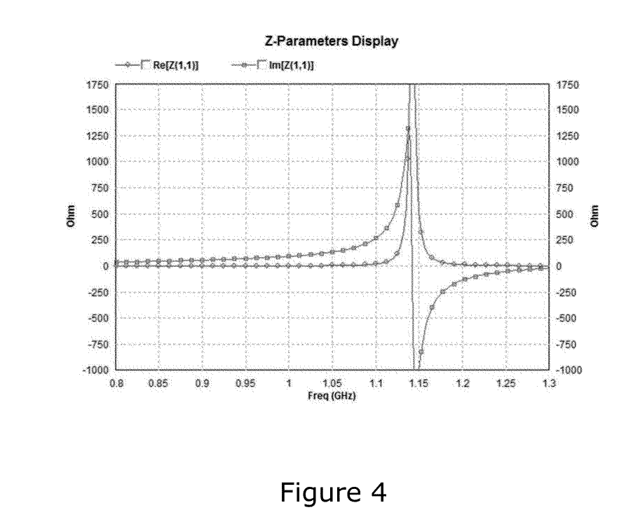

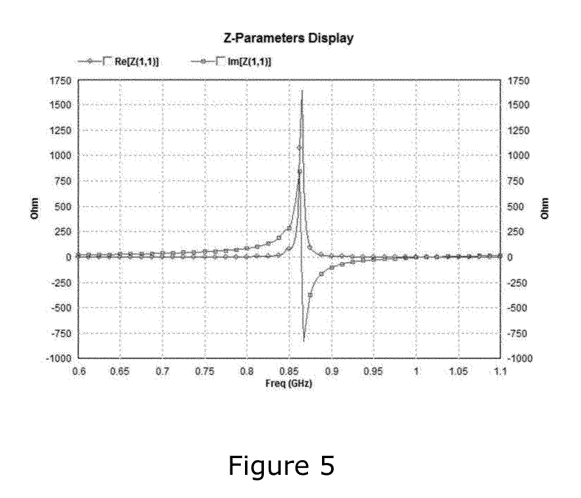

High dielectric material elements 112 and 114 are also mounted on an antenna 108. The high dielectric material elements 112 and 114 may comprise some plastics or any ceramics but typically comprises ceramic materials. High dielectric material 112 and 114 is typically attached to an antenna 108 with an industrial adhesive material. For all “low loss” dielectrics, permeability value is low. The invention could use any dielectric material. These materials are being used to lower the resonant frequency of the tag and are referred to herein as a resonant frequency lowering element. This characteristic is seen in FIGS. 3 and 4. They were used because the tag is physically smaller than it typically should be for operation in the UHF RFID frequency band. The dielectric materials, in concert with metallic foil (discussed below), shift the tag's operational frequency close to the desired frequency band where tuning features can then be used to “dial it in” (FIG. 5). Comparing FIGS. 4 and 5, it can be seen that the metallic foil reduces the resonant frequency AND the rate of change in the impedance. Since the impedance changes at a slower rate, it is “matched” or operational over a much wider bandwidth. A lower dielectric material will also work, but it would need to be larger (area) to have the same impact as a higher dielectric material. The material and size are dictated by how much of a frequency shift is needed as can be easily determined by one of ordinary skill in the art.

Metallic foil 116 is attached to a cover 106 (not shown in FIG. 1). The metallic foil typically covers the lower (underside) portion of the cover completely using an industrial adhesive. The cover 106 can comprise an RF friendly plastic or ceramic material and in a preferred embodiment is the same as the material used for the housing 104. The distance between metallic foil 116 and RFID chip 110 is also one of the variables which affect tuning. The dielectric material type, size, and distance from the metallic foil to the tag dictate the tag's resonant (operational) frequency. If the tag is larger, the dielectric material may not be needed. Metallic foil would certainly be used to achieve broadband performance

The cover 106 is attached to the housing 104 to enclose the housing 104. The attachment method may comprise an adhesive or mechanical device such as screws or rivets, and in a preferred embodiment is designed to assure survivability in line with the survivability of the housing 104 and cover 106 under conditions where temperatures range from −55 degrees Fahrenheit to 180 degrees Fahrenheit.

The size and shape of the shape of the antenna 108, enclosure 104, and cover 106, will vary based on the desired read performance and desired environmental durability. The tag is designed for, and optimum performance will be realized, when the tag is placed directly on metal. The tag could be mounted to the bottom of the housing. This space between antenna 108 and enclosure 104 is another factor which affects the tag's tuning. Broader frequency performance is achieved as the tag moves further from the bottom of the housing where the mounting or interface is with the asset.

FIGS. 3-5 show theoretical analyses of the antenna described above. FIG. 3 depicts the antenna impedance of the antenna without any modifications. FIG. 4 displays the antenna impedance with the ceramic loading. Ceramic loading shifts the natural antenna resonance shown in FIG. 3 from 1.29 GHz, to 1.14 GHz as shown in FIG. 4.

FIG. 5 displays the antenna impedance with both ceramic loading and the metallic foil. As can be seen, the natural resonance has shifted from 1.29 GHz (FIGS. 3) to 0.860 GHz. The rate of change in the antenna impedance from FIGS. 3-5 displays the effect which allows for broadband performance.

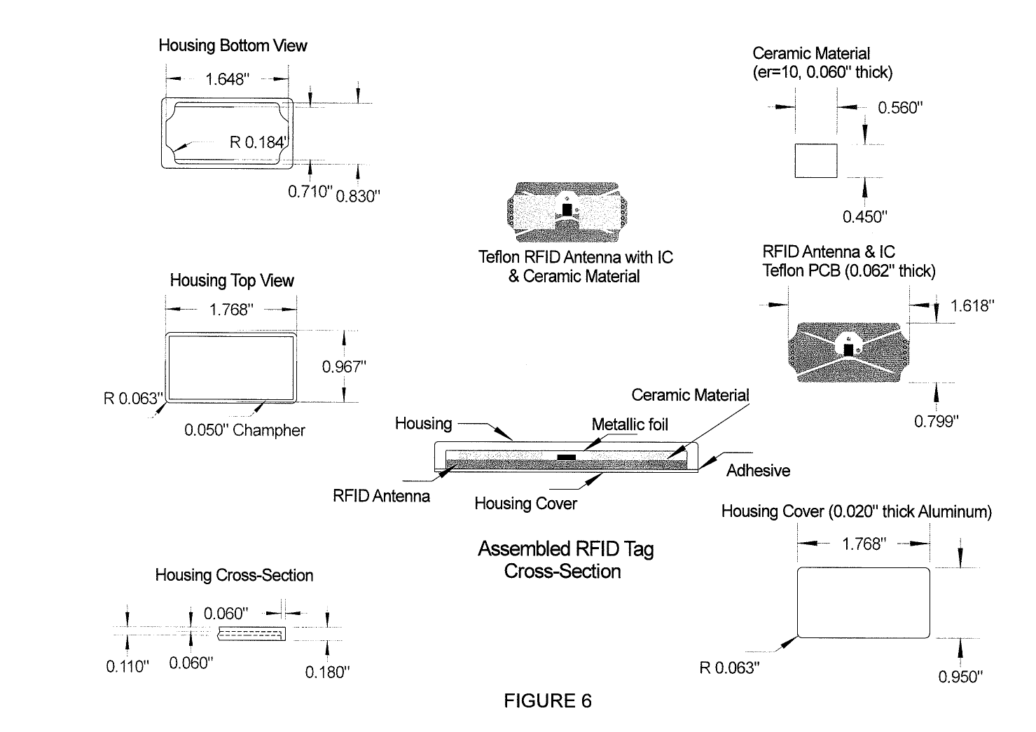

FIG. 6 illustrates dimensions and characteristics of a preferred embodiment. As discussed above, dimension and positioning can be selected differently to alter the operational characteristics of a device using the inventive concept. The dimensions, materials, and characteristics shown in FIG. 6 can be used to fabricate a preferred embodiment of the claimed invention, but it is understood that the dimensions, materials, and characteristics can be varied, as described herein, and still enable fabrication of an embodiment that falls within the scope of the appended claims.

Although the present invention has been described with respect to a specific preferred embodiment thereof, various changes and modifications may be suggested to one skilled in the art and it is intended that the present invention encompass such changes and modifications as fall within the scope of the appended claims.

I claim:

1. An RFID tag having operational bandwidth in the range of 866-954 MHz.

2. An RFID tag, comprising:
a bottom enclosure;
an antenna element situated within said bottom enclosure;
an RFID chip mounted on said antenna element;
a resonant frequency lowering element mounted on said antenna element adjacent to said RFID chip; and
a metallic foil element situated above said RFID chip and said dielectric material element, separated from said RFID chip and dielectric material element by a predetermined distance.

3. The RFID tag of claim 2, wherein said resonant frequency lowering element comprises a first dielectric material element.

4. The RFID tag of claim 3, wherein said resonant frequency lowering element further comprises a second dielectric material element.

5. The RFID tag of claim 3, wherein said first dielectric material element comprises ceramic.

6. The RFID tag of claim 2, further comprising a cover mountable to said bottom enclosure, wherein said metallic foil element is attached to said cover, on the interior thereof when said cover is mounted to said bottom enclosure.

7. The RFID tag of claim 6, wherein said RFID tag is made of materials which assure survivability of said RFID chip in a temperature range from −55° F. to +180° F.

8. A method for enabling the operation of an RFID tag within the entire operational range of 866-954 MHz, comprising:
shifting a natural resonance of an antenna of said RFID tag by ceramic loading the antenna.
